(19) United States
(12) Patent Application Publication
(10) Pub. No.: US 2013/0278861 A1
(43) Pub. Date: Oct. 24, 2013

(54) Backlight Module and LCD Device

(71) Applicants: Yuchun Hsiao, Shenzhen (CN); Yicheng Kuo, Shenzhen (CN); Chong Huang, Shenzhen (CN); Jiahe Cheng, Shenzhen (CN); Pangling Zhang, Shenzhen (CN)

(72) Inventors: Yuchun Hsiao, Shenzhen (CN); Yicheng Kuo, Shenzhen (CN); Chong Huang, Shenzhen (CN); Jiahe Cheng, Shenzhen (CN); Pangling Zhang, Shenzhen (CN)

(21) Appl. No.: 13/512,699

(22) PCT Filed: Apr. 23, 2012
(86) PCT No.: PCT/CN12/74521

§ 371 Date: May 30, 2012

(51) Int. Cl. F21V 29/00; G02F 1/13357

(52) U.S. Cl. 349/61; 362/600

(57) ABSTRACT

The invention relates to the field of LCDs, and more particularly to a backlight module and an LCD device. The backlight module includes a backplane, and a light source; the light source is arranged on the backplane, and the outer side surface of the backplane near the light source is provided with a heat pipe. The heat pipe is arranged on the outer side surface of the backplane of the backlight module of the invention near the light source; because light source is a heat emitting source, the nearer the heat pipe to the light source is, the higher the temperature is. By using the high-efficiency heat transfer mechanism of the heat pipe, the heat of the backplane is quickly dissipated outside the backplane, and the temperature inside the backplane, in particular the temperature near the light source is indirectly reduced; thus, the service life of the backlight module and the LCD device is extended.

### TECHNICAL FIELD

The invention relates to the field of liquid crystal displays (LCDs), and more particularly to a backlight module and an LCD device.

### BACKGROUND

An LCD device includes an LCD panel, and a backlight module; the backlight module provides a light source of one side for the LCD panel. The backlight module generally includes a backplane, a light guide panel (LGP), and a light source. The light sources of the conventional backlight module are divided into LED point light sources or CCFL line light sources. To meet the requirements of high brightness and light weight, the aforementioned light sources are generally arranged in a narrow airtight space, the heat generated by the light sources cannot be successfully dissipated during operation, and the continuously accumulated heat may cause the display quality of the backlight module and the LCD device to be reduced. For example, the image of partial area is easy to shake or flicker, and the service life of the light sources and the elements around the light sources are reduced; furthermore, the power of the light sources cannot be further increased to provide an LCD device with higher brightness.

### SUMMARY

In view of the above-described problems, the aim of the invention is to provide a backlight module and an LCD device with better heat dissipation effect.

A first technical scheme of the invention is that: a backlight module comprises a backplane, and a light source; the light source is arranged on the backplane, wherein the outer side surface of the backplane near the light source is provided with a heat pipe; both the light source and the heat pipe are arranged on the side wall of the backplane, and the heat pipe is positioned between the light source and the bottom wall of the backplane; the backplane is provided with a groove which is depressed to the inside of the backplane, and the heat pipe is arranged in the groove; the heat pipe is a tubular heat pipe, and the heat pipe is arranged in parallel with the light source along the whole length of the light source; the backplane comprises a frame and a bottom panel, and the frame is formed by mutually joining a plurality of frame brackets; the bottom panel is a hollow bottom panel formed by a plurality of grid bars fixed on the frame.

A second technical scheme of the invention is that: a backlight module comprises a backplane, and a light source; the light source is arranged on the backplane, and the outer side surface of the backplane near the light source is provided with a heat pipe.

Preferably, both the light source and the heat pipe are arranged on the side wall of the backplane, and the heat pipe is positioned between the light source and the bottom wall of the backplane. Thus, the height of the side wall of the backplane is not required to be added, the free space is skillfully used, and the heat pipe is kept to be near the light source, thereby dissipating heat to a maximum extent.

Preferably, the light source is arranged on the side wall of the backplane, and the heat pipe is positioned on the bottom wall of the backplane. When the space between the light source and the bottom wall of the backplane is inadequate to arrange the heat pipe, the heat pipe is arranged on the bottom wall of the backplane; thus, the heat pipe is still arranged near the light source, to achieve the aim of quick heat dissipation.

Preferably, both the light source and the heat pipe are arranged on the bottom wall of the backplane. For bottom-light backlight modules, such design can shorten the distance between the heat pipe and the light source as far as possible, because the nearer the heat pipe to the light source is, the better the heat dissipation effect is.

Preferably, the light source is arranged on the bottom wall of the backplane, and the heat pipe is arranged on the side wall of the backplane. Backlight modules are bottom-light backlight modules, and the distance between the heat pipe and the light source is shortened as far as possible, because the nearer the heat pipe to the light source is, the better the heat dissipation effect is.

Preferably, the backplane is provided with a groove which is depressed to the inside of the backplane, and the heat pipe is arranged in the groove. The groove adds the heat-absorbing area inside the backplane, and further adds the contact area between the heat pipe and the backplane; thus, heat is quickly dissipated. The groove cannot change the external dimension of the backplane, and cannot affect other components.

Preferably, the heat pipe is a tubular heat pipe, and the heat pipe is arranged in parallel with the light source along the whole length of the light source. Thus, uniform heat dissipation effect is obtained. In addition, because of taking small volume, the tubular heat pipe can be conveniently arranged in the groove of the backplane.

Preferably, the backplane comprises a frame and a bottom panel, and the frame is formed by mutually joining a plurality of frame brackets.

Preferably, the bottom panel is a hollow bottom panel formed by a plurality of grid bars fixed on the frame.

The invention further provides a third technical scheme: an LCD device comprises a backlight module mentioned above.

Advantages of the invention are summarized below: the heat pipe is arranged on the outer side surface of the backplane of the backlight module of the invention near the light source. Because the light source is a heat emitting source, the nearer the heat pipe to the light source is, the higher the temperature is. By using the high-efficiency heat transfer mechanism of the heat pipe, the heat of the backplane is quickly dissipated outside the backplane, and the temperature inside the backplane, in particular the temperature near the light source is indirectly reduced; thus, the service life of the backlight module and the LCD device is extended, and the power of the light source is further increased to provide an LCD device with higher brightness.

### BRIEF DESCRIPTION OF FIGURES

FIG. 1 is a partial sectional view of a first example of a backlight module of the invention;

FIG. 2 is a structure diagram of a backplane shown in FIG. 1; and

FIG. 3 is a partial sectional view of a second example of a backlight module of the invention;

Legends: 1. backplane; 11. side wall; 12. bottom wall; 13. groove; 14. frame bracket; 15. grid bar; 2. light source; 3. heat pipe; 4. LGP.

### DETAILED DESCRIPTION

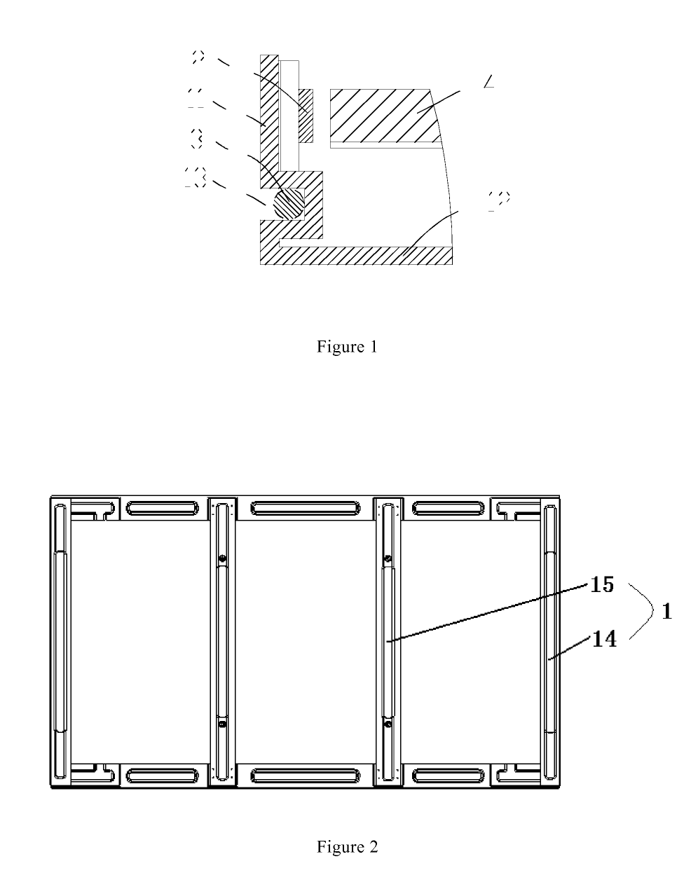

The invention provides an LCD device, comprising a backlight module. FIG. 1 and FIG. 2 show a first example of the backlight module of the invention. The backlight module comprises a backplane 1, and a light source 2; the light source 2 is arranged on the backplane 1, the outer side surface of the backplane 1 near the light source 2 is provided with a heat pipe 3, and an LGP 4 is arranged corresponding to the light source 3.

The heat pipe 3 is arranged on the outer side surface of the backplane 1 of the backlight module of the invention near the light source 2. Because the light source is a heat emitting source, the nearer the heat pipe to the light source 2 is, the higher the temperature is. By using the high-efficiency heat transfer mechanism of the heat pipe 3, the heat of the backplane 1 is quickly dissipated outside the backplane 1, and the temperature inside the backplane 1, in particular the temperature near the light source 2 is indirectly reduced; thus, the service life of the backlight module and the LCD device is extended, and the power of the light source 2 is further increased to provide an LCD device with higher brightness.

In the example, both the light source 2 and the heat pipe 3 are arranged on the side wall 11 of the backplane, the backlight module is a side-light backlight module, and the heat pipe 3 is positioned between the light source 2 and the bottom wall 12 of the backplane. Thus, the height of the side wall 11 of the backplane is not required to be added, the free space is skillfully used, and the heat pipe 3 is kept to be near the light source 2, thereby dissipating heat to a maximum extent.

In the example, the heat pipe 3 is a tubular heat pipe, the backplane 1 is provided with a groove 13 which is depressed to the inside of the backplane, and the heat pipe 3 is arranged in the groove 13. Because the light source 2 is a long strip-shaped lightbar in general, the invention employs the tubular heat pipe, and the heat pipe 3 is arranged in parallel with the light source 2 along the whole length of the light source 2, uniform heat dissipation effect is obtained. In addition, because of taking small volume, the tubular heat pipe can be conveniently arranged in the groove 13 of the backplane 1. The groove 13 adds the heat-absorbing area inside the backplane 1, and further adds the contact area between the heat pipe 3 and the backplane 1; thus, heat is quickly dissipated. The groove 13 cannot change the external dimension of the backplane 1, and cannot affect other components.

In the example, as shown in FIG. 2, the backplane 1 comprises a frame formed by mutually joining a plurality of frame brackets 14, and a hollow bottom panel formed by a plurality of grid bars 15 fixed on the frame. The backplane in the prior art is integratedly punch formed. By analyzing the cost of the backplane, the inventor finds that the material of the backplane accounts for a great proportion, and the cost of the backplane cannot be further reduced when using the integrated molded structure. However, in the invention, the backplane 1 is divided into a plurality of frame brackets 14 and grid bars 15, and then the components are integratedly joined by welding, screwing, riveting, etc.; thus, the material cost can be reduced. The frame brackets 14 and the grid bars 15 has high generality, and can form backplanes 1 of different sizes; therefore, the development cost of special purpose dies is saved, and then the cost of the LCD device is reduced.

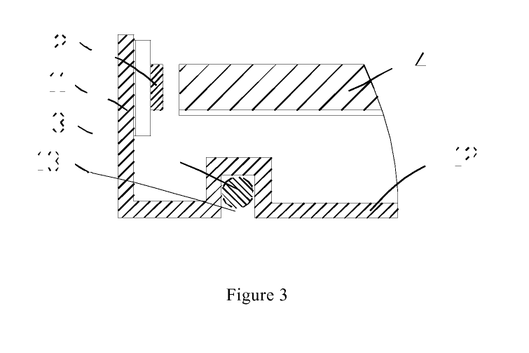

FIG. 3 shows a second example of the backlight module of the invention, and the second example is different from the first example in that: the light source 2 is arranged on the side wall 11 of the backplane 1, and the heat pipe 3 is positioned on the bottom wall 12 of the backplane. When the space between the light source 2 and the bottom wall 12 of the backplane is inadequate to arrange the heat pipe 3, the heat pipe 3 is arranged on the bottom wall 12 of the backplane; thus, the heat pipe 3 is still arranged near the light source 2, to achieve the aim of quick heat dissipation.

When the light source of the backlight module is arranged on the bottom wall of the backplane, the backlight module is called bottom-light backlight module. At this moment, the heat pipe can be arranged on the side wall of the backplane, and can be arranged on the bottom wall of the backplane as well. The distance between the heat pipe and the light source is shortened as far as possible, because the nearer the heat pipe to the light source is, the better the heat dissipation effect is.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A backlight module, comprising: a backplane, and a light source; wherein said light source is arranged on said backplane, and the outer side surface of said backplane near said light source is provided with a heat pipe; both said light source and said heat pipe are arranged on the side wall of said backplane, and said heat pipe is positioned between said light source and the bottom wall of said backplane, said backplane is provided with a groove which is depressed to the inside of said backplane, and said heat pipe is arranged in said groove; said heat pipe is a tubular heat pipe, and said heat pipe is arranged in parallel with said light source along the whole length of said light source; said backplane comprises a frame and a bottom panel, and said frame is formed by mutually joining a plurality of frame brackets; said bottom panel is a hollow bottom panel which is formed by a plurality of grid bars fixed on said frame.

2. A backlight module, comprising: a backplane, and a light source; wherein said light source is arranged on said backplane, and the outer side surface of said backplane near said light source is provided with a heat pipe.

3. The backlight module of claim 2, wherein both said light source and said heat pipe are arranged on the side wall of said backplane, and said heat pipe is positioned between said light source and the bottom wall of said backplane.

4. The backlight module of claim 2, wherein said light source is arranged on the side wall of said backplane, and said heat pipe is arranged on the bottom wall of said backplane.

5. The backlight module of claim 2, wherein both said light source and said heat pipe are arranged on the bottom wall of said backplane.

6. The backlight module of claim 2, wherein said light source is arranged on the bottom wall of said backplane, and said heat pipe is arranged on the side wall of said backplane.

7. The backlight module of claim 2, wherein said backplane is provided with a groove which is depressed to the inside of said backplane, and said heat pipe is arranged in said groove.

8. The backlight module of claim 7, wherein said heat pipe is a tubular heat pipe, and said heat pipe is arranged in parallel with said light source along the whole length of said light source.

9. The backlight module of claim 2, wherein said backplane comprises a frame and a bottom panel, and said frame is formed by mutually joining a plurality of frame brackets.

10. The backlight module of claim 9, wherein said bottom panel is a hollow bottom panel which is formed by a plurality of grid bars fixed on said frame.

11. An LCD device, comprising: a backlight module; wherein said backlight module comprises a backplane, and a light source; said light source is arranged on said backplane, and the outer side surface of said backplane near said light source is provided with a heat pipe.

12. The LCD device of claim 11, wherein both said light source and said heat pipe are arranged on the side wall of said backplane, and said heat pipe is positioned between said light source and the bottom wall of said backplane.

13. The LCD device of claim 11, wherein said light source is arranged on the side wall of said backplane, and said heat pipe is arranged on the bottom wall of said backplane.

14. The LCD device of claim 11, wherein both said light source and said heat pipe are arranged on the bottom wall of said backplane.

15. The LCD device of claim 11, wherein said light source is arranged on the bottom wall of said backplane, and said heat pipe is arranged on the side wall of said backplane.

16. The LCD device of claim 11, wherein said backplane is provided with a groove which is depressed to the inside of said backplane, and said heat pipe is arranged in said groove.

17. The LCD device of claim 16, wherein said heat pipe is a tubular heat pipe, and said heat pipe is arranged in parallel with said light source along the whole length of said light source.

18. The LCD device of claim 11, wherein said backplane comprises a frame and a bottom panel, and said frame is formed by mutually joining a plurality of frame brackets.

19. The LCD device of claim 18, wherein said bottom panel is a hollow bottom panel which is formed by a plurality of grid bars fixed on said frame.
